(19) United States
(12) Patent Application Publication
(10) Pub. No.: US 2006/0081740 A1
(43) Pub. Date: Apr. 20, 2006

(54) Collapsible portable welding stand

(76) Inventor: Bob Bellavance, Rocky Mountain House (CA)

Correspondence Address: Sander Gelsing, 600, 4911 - 51 Street, Red Deer, AB, T4N 6V4, CA

(21) Appl. No.: 11/247,384

(22) Filed: Oct. 12, 2005

(30) Foreign Application Priority Data
Oct. 15, 2004 (CA) 2,484,908

(51) Int. Cl. F16M 11/00; F16M 11/38

(52) U.S. Cl. 248/176.1; 248/166

(57) ABSTRACT

A collapsible portable welding stand is provided which can be moved between a storage position and a generally upright triangular-shaped support position. The welding stand comprises a framework having a base member, a first leg element and a second leg element, a support mounted on one of the leg elements, and locking means for locking the framework in the support position. In one embodiment the leg elements are pivotally linked together at a joint connection and the base member is pivotally linked to one of said leg elements. In another embodiment, the base member is pivotally linked to both leg elements and the leg elements pivotally linked together at a slidable joint connection.

### FIELD OF THE INVENTION

The field of present invention relates generally to providing a collapsible stand and, more particularly, to providing a stand for supporting pipe and other metal items during welding operations.

### BACKGROUND OF THE INVENTION

To prepare for the welding and fabrication of metal pipe, welders typically support a particular section of pipe, that is next in line to be welded, with a V-top bracket mounted on a traditional tripod stand. At other times, a bracket having pipe rollers is supported by a tripod stand.

However, the tripod stands have a tendency to tip over or collapse under the weight of a pipe section. An advantage therefore exists for a stand to safely support metal pipe sections, or other objects, while still being collapsible and portable.

### SUMMARY OF THE INVENTION

The collapsible portable welding stand according to the present invention can be moved between a collapsed storage position and a generally triangular-shaped support position. The welding stand comprises a framework having a base member, a first leg element, a second leg element, a support mounted on one of the leg elements, and locking means for locking the framework in the support position. Preferably the stand further comprises one or more laterally extending feet and additional securing means to keep it locked in the support position.

In one embodiment, the base member is pivotally linked to both leg elements and the leg elements pivotally linked together at a slidable joint connection. Locking of the stand in the support position is accomplished by locking the slidable joint connection against one of the leg members.

In another embodiment the leg elements are pivotally linked together at a joint connection and the base member is pivotally linked to only one of said leg elements. Locking of the stand in the support position is accomplished by means of a pin depending from the base member and receivable in a hole in the other leg element.

### BRIEF DESCRIPTION OF THE DRAWINGS

FIG. 1 is a side perspective view of one embodiment of the stand according to the present invention, shown in the support position;

FIG. 2 is a side view of the stand of the embodiment of FIG. 1, also shown in the support position;

FIG. 3 is a side view of the stand of the embodiment of FIG. 1, shown in the collapsed storage position;

FIGS. 4-15 and 25 are various perspective views of the stand of the embodiment of FIG. 1, shown in a variety of positions;

FIGS. 16-24 are various perspective views of a second embodiment of the stand, shown in a variety of positions;

FIG. 26 is a side perspective view of a third embodiment of the stand, shown in the support position; and

FIG. 27 is a side perspective view of a fourth embodiment of the stand, shown in the support position.

### DETAILED DESCRIPTION OF THE PREFERRED EMBODIMENTS

Reference is to be had to the Figures in which identical reference numbers identify similar components.

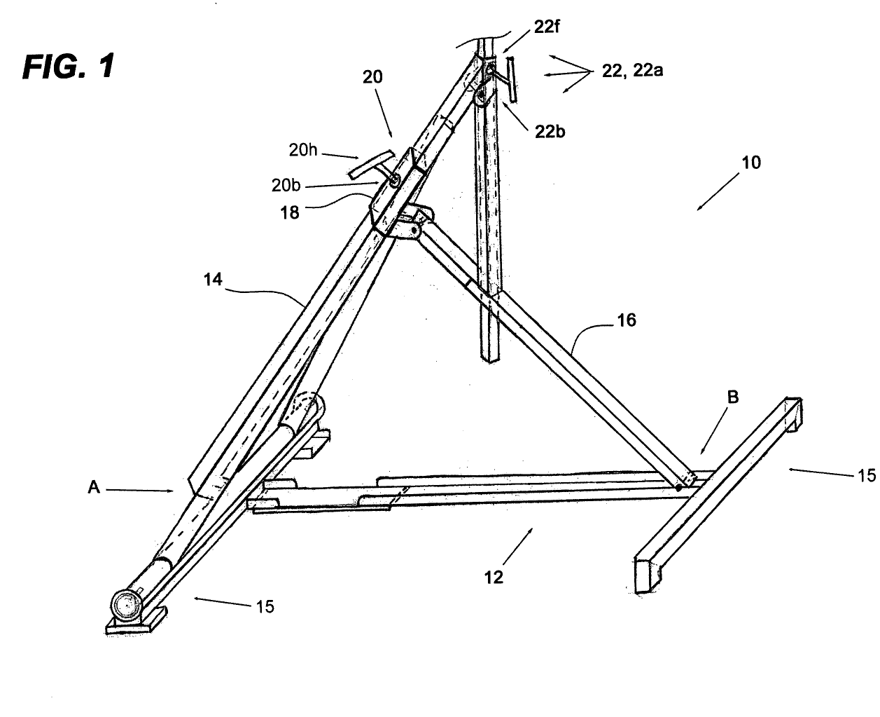

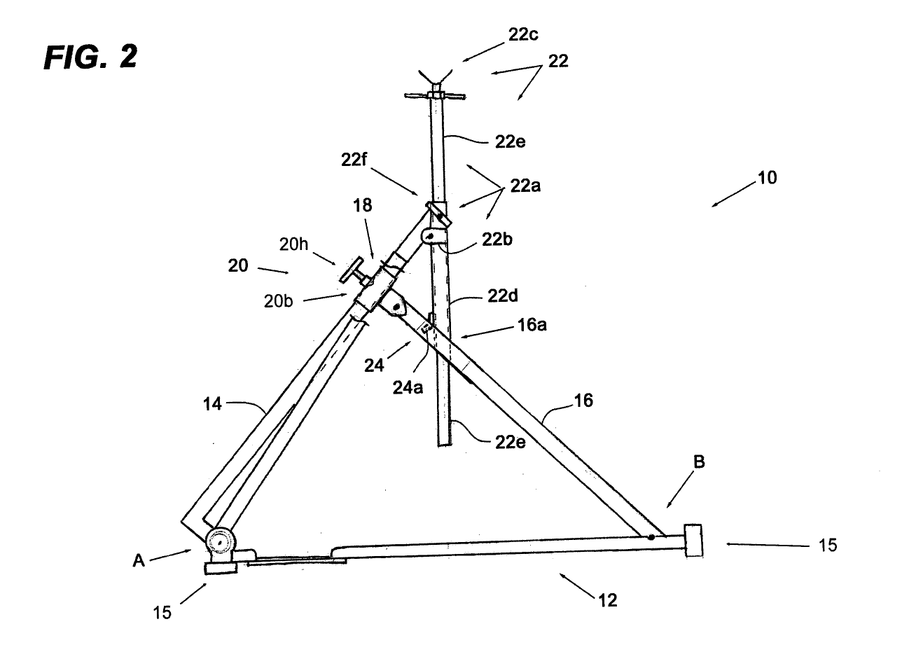

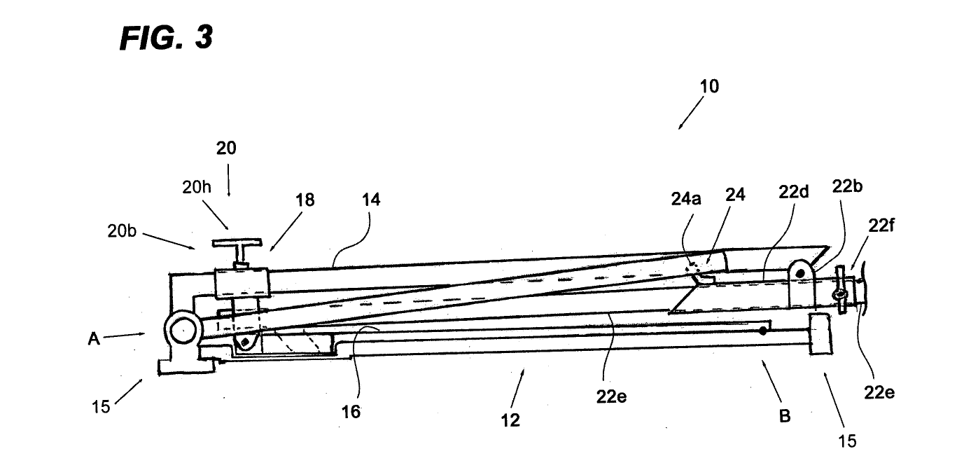

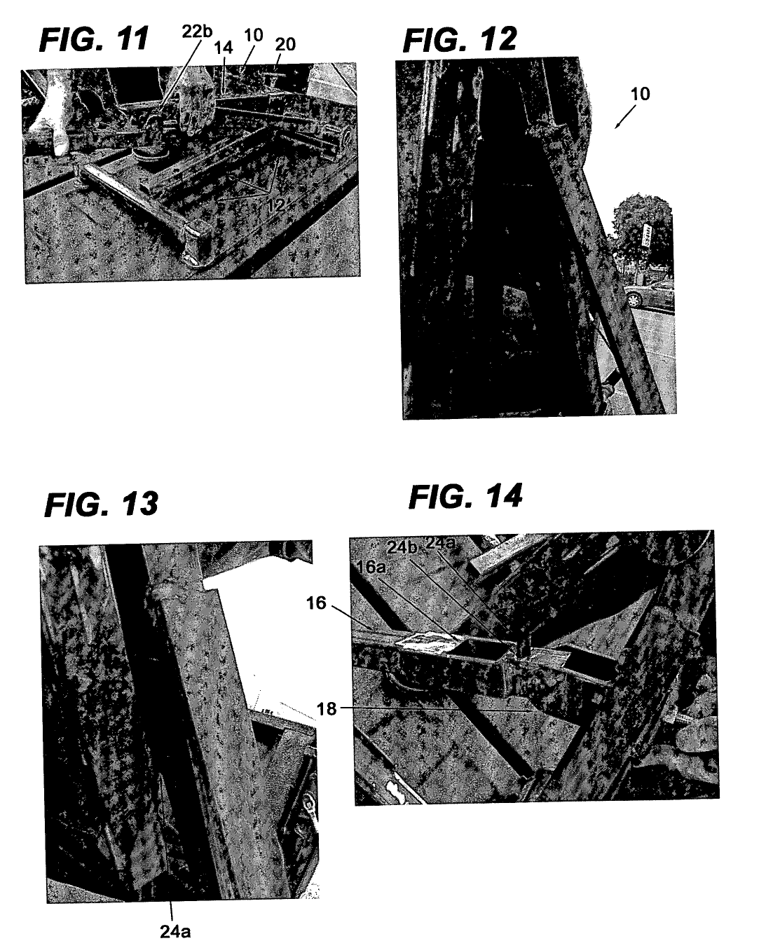

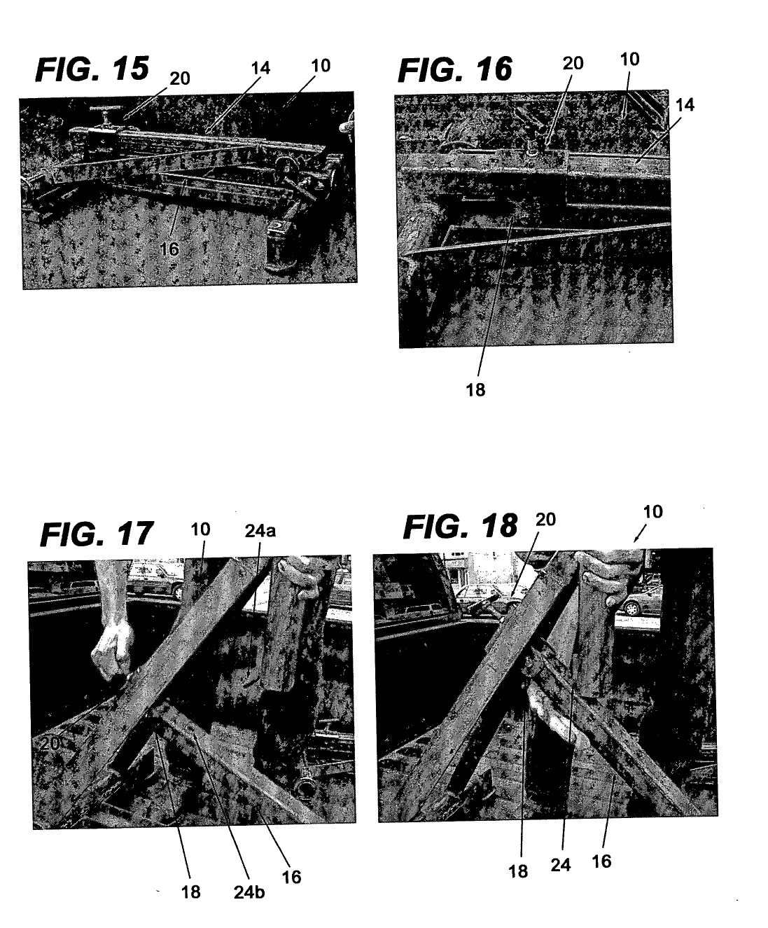

Referring to FIGS. 1-15 and 25, one embodiment of a stand 10 of the present invention is shown. The stand 10 generally includes a base member 12, a first leg member or element 14, a second leg member or element 16. In this embodiment, the leg elements 14, 16 are pivotally linked together at a joint connection 18 for pivotal movement with respect to one another between a substantially parallel storage position (see FIG. 3) and an angled support position (see FIGS. 1-2). Further, in this embodiment, the base member 12 is pivotally linked to both leg elements 14, 16, at pivot points A and B respectively, and the joint connection 18 between the leg elements 14, 16 is established by a slidable pivot mount 18, as more clearly shown in FIGS. 1, 2, 7 and 8.

The pivot mount 18 is slidably connected to the first leg element 14, so as to enable pivot mount 18 to slidably move along substantially the length of first leg element 14. The pivot mount 18 is pivotally connected to the second leg element 16, as shown more clearly in FIGS. 1,2, 7 and 8.

The stand 10 further comprises a pivot mount locking means 20 to lock or secure the stand 10 in the support position. In this embodiment, the locking means 20 causes for the pivot mount 18 to be locked against the first leg element 14. Means to lock a sliding member against a stationary leg element are well known in the art. Further in this embodiment, the locking means 20 comprises a threaded handle 20h inserted through a matching threaded borehole 20b on the pivot mount 18. Locking occurs by the handle 20h being threaded through the borehole 20b then striking and frictionally engaging the leg element 14, thereby forcing said leg element 14 against the inside surface of the mount 18. In another embodiment (not shown), the locking means 20 comprises a pin insertable through a borehole in the pivot mount 18 and through a corresponding borehole in the leg element 14, located at an appropriate position along the leg element's length.

Preferably, the base 12 further comprises a pair of laterally extending feet 15, one foot 15 near each of points A and B. Advantageously, the feet 15 provide additional stability to the stand 10. In another embodiment (not shown), the base 12 further comprises a generally horizontal plate to contact the ground or surface and to provide additional stability to the stand 10. More preferably, the components of the stand 10 are made of steel or any other suitable material of high strength and rigidity.

The stand 10 further comprises a support or support means 22 mounted on one of the leg elements 14 or 16 for supporting a section of pipe or other item. In this embodiment, the support 22 is mounted on the first leg element 14 and comprises a telescoping support 22a, a second pivot mount 22b and a V-top bracket 22c. The V-top bracket 22c is mounted on the telescoping support 22a at one end. The telescoping support 22a is pivotally connected to the first leg element 14 near the end of the first leg element 14, opposite to pivot point A, via the second pivot mount 22b, as shown more clearly in FIGS. 1-2. In this embodiment, the telescoping support 22a comprises telescope sleeve 22d, telescope bar 22e and telescope locking means 22f. The telescope sleeve 22d is mounted to the second pivot mount 22b as shown more clearly in FIGS. 1-2. The telescope bar 22e is slidedly mounted within the telescope sleeve 22d. Telescope locking means 22f functions to hold telescope bar 22e at certain slideable positions relative to telescope sleeve 22d. Additionally, in this embodiment second leg element 16 has a telescope opening 16a therethrough to allow the telescoping bar 22e to pass through the second leg element 16 as may be desired.

In another embodiment (not shown), support means 22 comprises a V-top bracket directly mounted or connected to the first leg element 14 at an appropriate angle. In yet another embodiment (also not shown), support means 22 comprises a bracket with pipe rolling means mounted directly on one of the leg elements 14, 16.

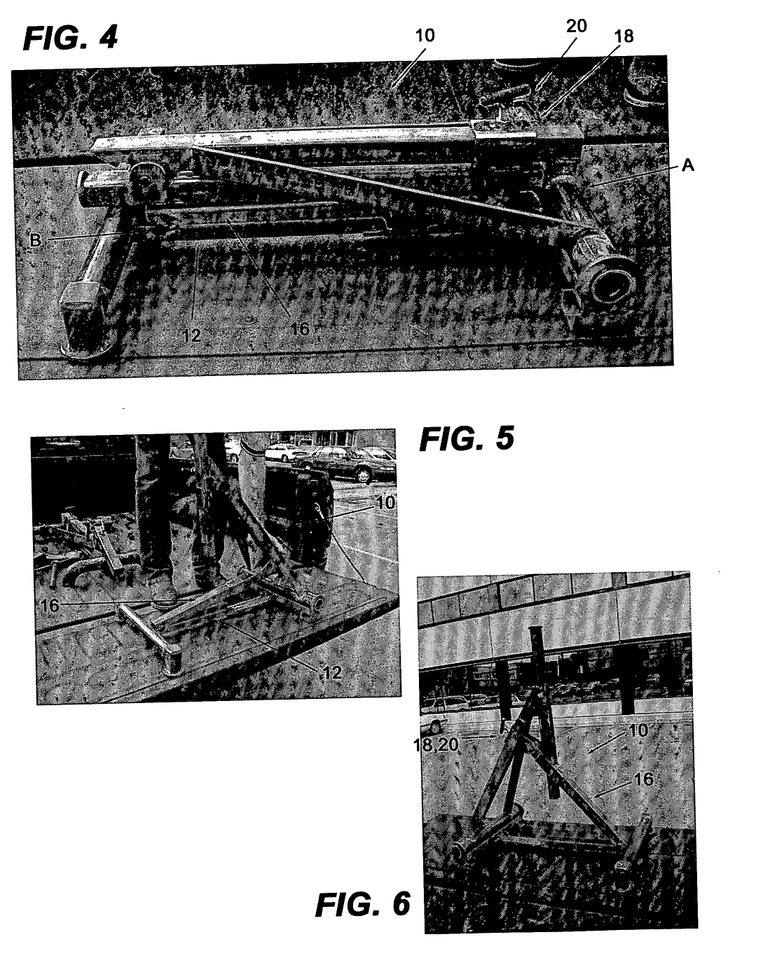

The base 12 and leg elements 14, 16 thus form a framework which may be displaced from a storage position, where the base 12 and leg elements 14, 16 are substantially parallel to each other (see FIGS. 3 and 4), to a support position, where the base 12 and leg elements 14, 16 are fashioned into a generally triangular-shaped framework (see FIGS. 1, 2 and 6).

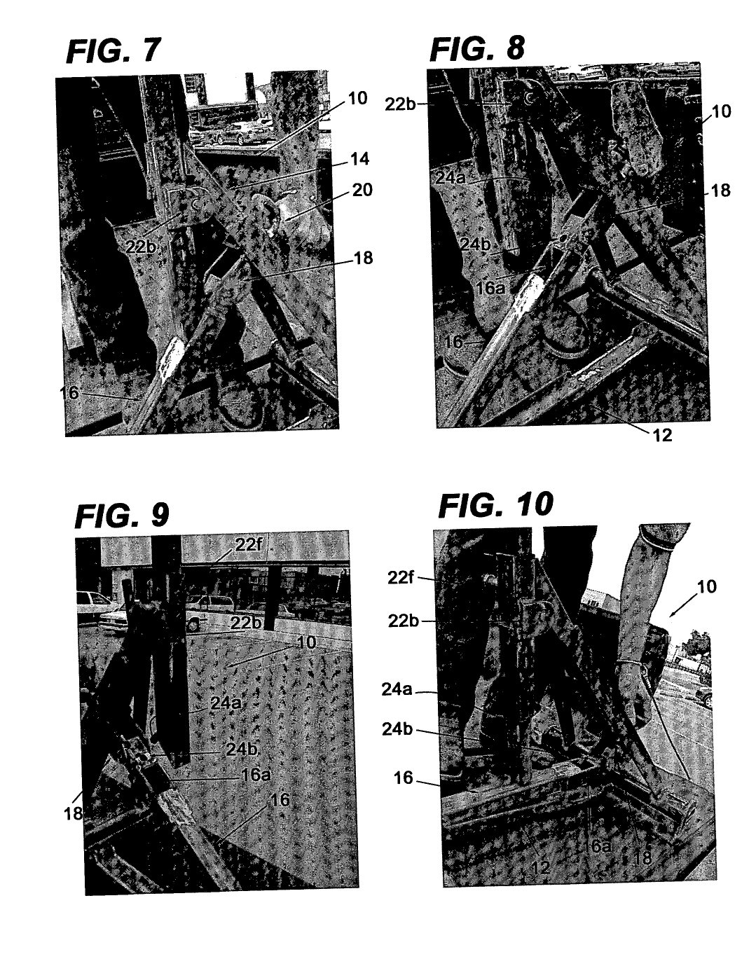

In this embodiment, the displacement of the stand 10 from a storage position (see FIG. 3) to a support position (see FIGS. 1-2) is accomplished as follows. The first leg element 14 is pivoted upward relative to the base 12 as can be seen in FIG. 5. The pivot mount 18 is slidably moved from the bottom end of the first leg element 14 towards the top end of the first leg element 14 (see FIG. 6). The locking means 20 is engaged so as to secure the sliding pivot mount 18 near the top end of the first leg element 14 (see FIGS. 7 and 8) thereby locking the stand 10 in the support position.

Preferably the stand 10 further comprises additional securing means 24. In a preferred embodiment, the additional securing means 24 comprises pin 24a depending from the telescoping sleeve 22d and a recess or opening 24b in second leg element 16. The pin 24a depends from the telescope sleeve 22d at an appropriate angle so as to engage the recess 24b when the stand 10 is in the support position as more clearly shown in FIGS. 2 and 14.

### SECOND EMBODIMENT

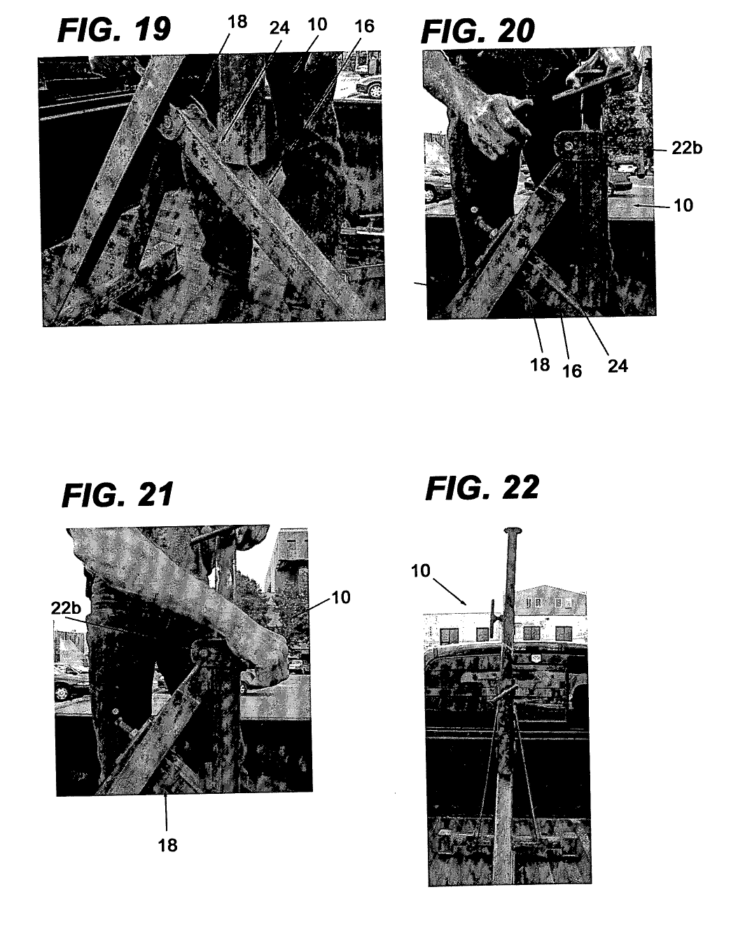

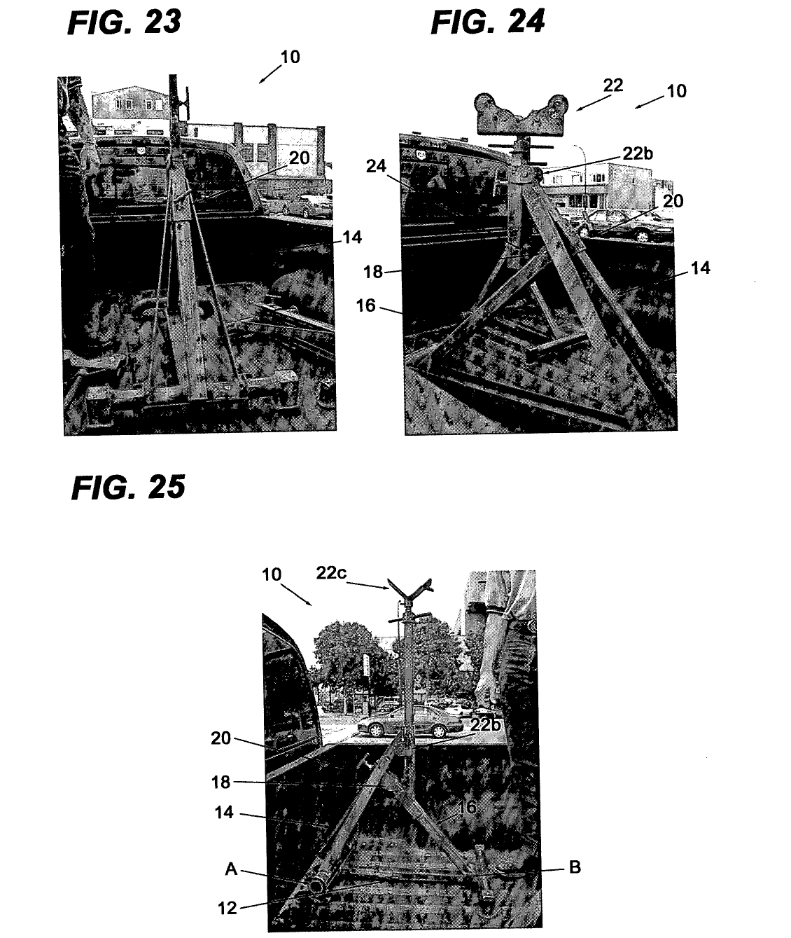

FIGS. 17 to 24 illustrate a second embodiment of the stand 10. This embodiment of the stand 10 is similar to the first embodiment as discussed above with the following notable differences. The second leg element 16 of this embodiment of the stand 10 does not have a telescope opening therethrough. Also, the pivot mount 22b is attached at a different position on the first leg element 14 when compared to the first embodiment shown in FIGS. 1-15 and 25. Operation of the stand 10 of the second embodiment is similar to the operation of the stand 10 of the first embodiment as discussed above.

### THIRD EMBODIMENT

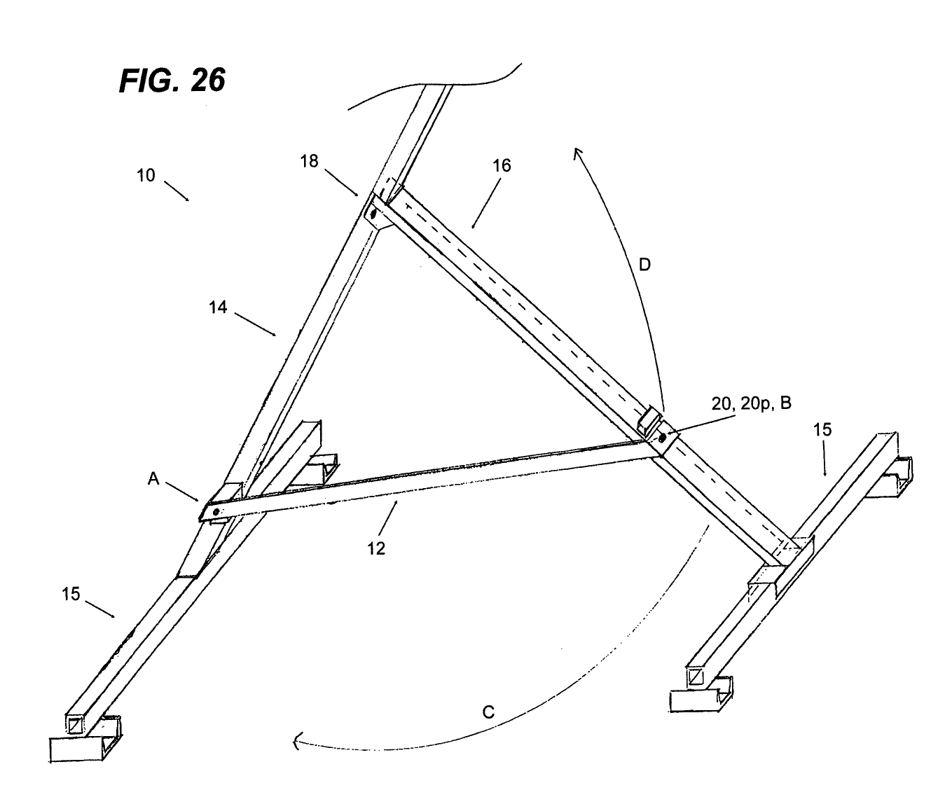

FIG. 26 illustrates a third embodiment of the stand 10. This embodiment of the stand 10 is similar to the first embodiment as discussed above with the following notable differences. The pivotal joint connection 18 between the leg elements 14, 16 is not slidable but is a stationary pivot mount 18 instead. Further in this embodiment, the base member 12 is pivotally linked to only the first leg elements 14, at pivot point A, and locking means 20 (for locking the stand 10 in the support position) comprises a pin 20p depending from the base member 12 and a corresponding recess or opening in second leg element 16. The pin 20p depends from the base member 12 at an appropriate angle so as to engage the recess or opening when the stand 10 is in the support position. Preferably, lateral feet 15 are attached to each of the leg elements 14, 15.

Alternatively, and in another embodiment (not shown), the locking means 20 comprises two openings or holes, one through the base member 12 and a corresponding one in the second leg element 16, and a removable pin positionable therethrough so as to secure the stand 10 in the support position.

Displacement of the third embodiment of the stand 10 from the support position (as shown in FIG. 26) to a storage position (not shown) is accomplished as follows. The locking means 20 is disengaged so that the base 12 can be detached from the second leg element 16. The second leg element 16 is then pivoted in direction C, from an angled position to a substantially parallel position relative to the first leg element 14. The base 12 is then pivoted in direction D so as to become substantially parallel to both leg elements 14, 16.

### FOURTH EMBODIMENT

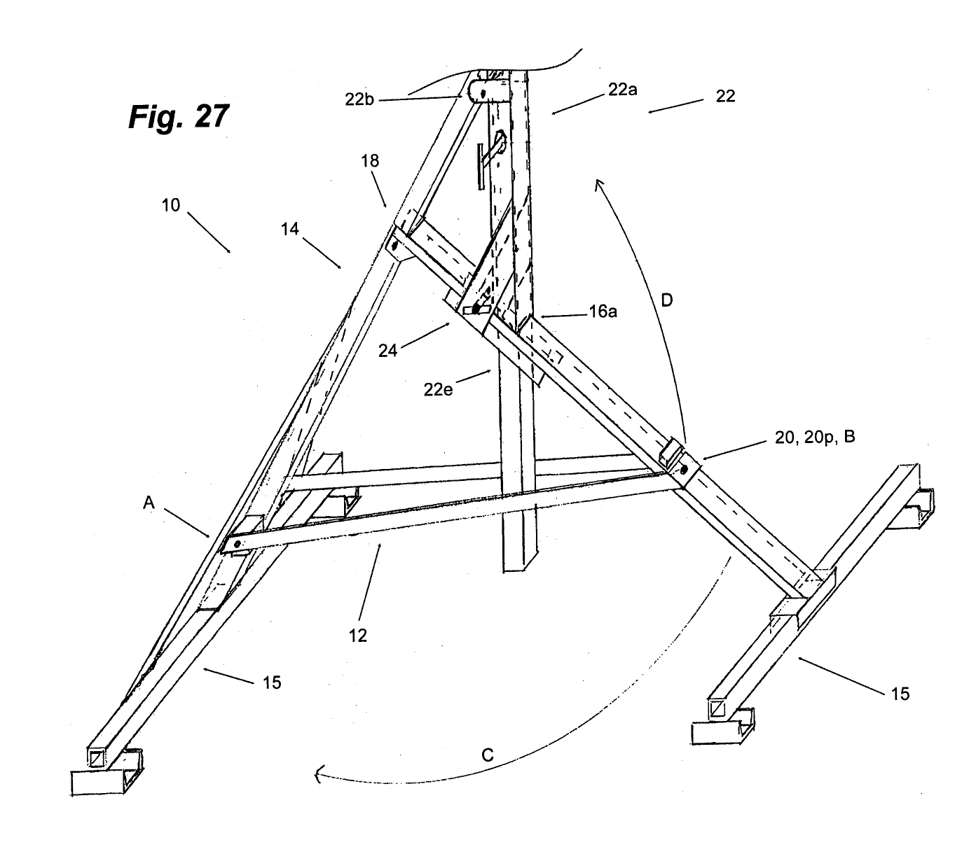

FIG. 27 illustrates a fourth embodiment of the stand 10. This embodiment of the stand 10 is similar to the thirds embodiment as discussed above, but the support 22 is mounted on the first leg element 14 and further comprises a telescoping support 22a mounted to pivot mount 22b, much like the telescoping support 22a in the first embodiment. Like the first embodiment, the second leg element 16 in this embodiment has a telescope opening 16a to allow the telescoping bar 22e to pass therethrough as may be desired. Additional securing means 24, in the form of a removable pin through corresponding holes in the second leg element 16 and telescoping support 22a, is also provided. Operation of the stand 10 of the fourth embodiment is similar to the operation of the stand 10 of the third embodiment as discussed above.

The stand 10 of the present invention, in its various embodiments, is more stable than traditional tripod stands and can be built in a variety of different sizes as may be desired (whereas tripod stands traditionally are limited to a certain upper size before they become too awkward and unwieldy to use efficiently). The stand 10 may also be used for purposes other than welding and the support 22 used to support a wide variety of objects.

The embodiments of the invention in which an exclusive property or privilege is being claimed are defined as follows:

1. A stand comprising:
a collapsible framework having a base member, a first leg element and a second leg element, said framework being moveable between a storage position and a generally upright triangular-shaped support position;
a support mounted on the framework; and
locking means for locking the framework in the support position.

2. The stand of claim 1 wherein the leg elements are pivotally linked together at a joint connection and the base member is pivotally linked to one of said leg elements.

3. The stand of claim 1 wherein the base member is pivotally linked to both leg elements and the leg elements are pivotally linked together at a slidable joint connection.

4. A stand comprising:
two leg elements, said leg elements being pivotally linked together at a joint connection for pivotal movement with respect to one another between a substantially parallel storage position and an angled support position;
a base member;
a support mounted on one of said leg elements; and
means for locking said leg members in the support position.

5. The stand of claim 4 wherein the base member is pivotally linked to one of said leg elements.

6. The stand of claim 4 wherein the base member is pivotally linked to both leg elements and the joint connection between the leg elements is slidable along one of the leg elements.
